(19) United States
(12) Patent Application Publication
(10) Pub. No.: US 2019/0240573 A1
(43) Pub. Date: Aug. 8, 2019

(54) METHOD FOR CONTROLLING CHARACTERS IN VIRTUAL SPACE

(71) Applicant: XVI Inc., Tokyo (JP)

(72) Inventors: Yoshihito KONDOH, Tokyo (JP); Masato MUROHASHI, Tokyo (JP)

(21) Appl. No.: 16/265,695

(22) Filed: Feb. 1, 2019

(30) Foreign Application Priority Data
Feb. 2, 2018 (JP) 2018-017258

(51) Int. Cl. A63F 13/428; A63F 13/25; A63F 13/23

(52) U.S. Cl. CPC A63F 13/428; G06F 3/0482; A63F 13/23; A63F 13/25

(57) ABSTRACT

A method for controlling a character in a virtual space provided to a plurality of user devices, including, placing a character played by a first user in a virtual space displayed on respective user devices, detecting an input of the first user through any one of a head mounted display or a controller attached to the first user, controlling motion of the character based on the input of the first user, displaying a plurality of selectable objects in an area different from the virtual space, receiving a selection of an object of any one of the plurality of objects from a user device associated with a second user of any one of the plurality of user devices, placing the one object in the virtual space, and when an input of the first user for the one object is detected, controlling the character so as to grab the object.

### TECHNICAL FIELD

The present invention relates to a method for controlling a character in a virtual space. More particularly, the present invention relates to a method for controlling a character using a device, for example, a head mounted display (HMD) that can be mounted on a body part of a user, such as the head part.

### BACKGROUND ART

Motion capture is a technique to digitally capture the movement of an actor in real space, and the captured motion is used for computer animation such as animation and expression of the movement of a character in a game or the like.

Optical and mechanical methods and the like are being adopted as conventional motion capture technology. First, as an example of an optical method, actors wear a full body suit provided with markers, and by arranging a plurality of trackers such as digital cameras to track the markers in a specific space such as a room or a film studio, the reflection of the markers are captured by the trackers. By analyzing the change of the position of the markers for each frame, the movement of the actor in time series is configured as a spatial representation. By applying this spatial representation to control a character in virtual space, it is possible to reenact the movement of an actor with a movement of a character. As an example of a technique for improving the tracking accuracy of the optical motion capture technology, there is the technique disclosed in Japanese Patent Laid-Open Publication No. 2012-248233. Further, as an example of a mechanical method, there is a method of installing acceleration, gyroscope, and geomagnetic sensors on the whole body of an actor and applying the movement of the actor detected by the sensors to the control of a character in virtual space. An example of a motion capture technique using sensors is disclosed in Japanese Patent Laid-Open Patent Publication No. 2016-126500.

### PRIOR ART DOCUMENT

### Patent Document

(Patent Document 1) Japanese Patent Laid-Open Publication No. 2012-248233

(Patent Document 2) Japanese Patent Laid-Open Patent Publication No. 2016-126500

### DETAILED DESCRIPTION OF THE INVENTION

### Technical Problem

The technique disclosed in the above document requires adoption of a dedicated motion capture system in order to control a character in virtual space. In particular, an actor needs to wear markers or sensors to the whole body, and to increase the number of markers and sensors in order to improve accuracy.

Therefore, an object of the present invention is directed to providing a technique for realizing the movement of an actor in real space into the movement of a character in a virtual space through a simpler method.

### Technical Solution

A method for controlling a character in a virtual space provided according to an embodiment of the present invention, is a method for controlling a character in a virtual space provided to a plurality of user devices, including, placing a character played by a first user in a virtual space displayed on respective user devices of the plurality of user devices, detecting an input of the first user through any one of a head mounted display or a controller attached to the first user, controlling motion of the character based on the input of the first user, displaying a plurality of selectable objects in an area different from the virtual space in the respective user devices, receiving a selection of an object of any one of the plurality of objects from a user device associated with a second user of any one of the plurality of user devices, placing the one object in the virtual space, and when an input of the first user for the one object is detected, controlling the character so as to grab the object.

### Advantageous Effects

According to the present invention, by controlling the movement or the like of a character placed in a virtual space based on a user input detected via a head mounted display, it is made possible to reenact the movement of a user in real space as a movement of a character in virtual space in a simpler manner.

### BRIEF DESCRIPTION OF THE DRAWINGS

FIG. 1 illustrates a schematic diagram of an appearance of a head mounted display 110 according to a first embodiment.

FIG. 2 illustrates a schematic diagram of an appearance of a controller 210 according to the first embodiment.

FIG. 3 illustrates a block diagram of an HMD system 300 according to the first embodiment.

FIG. 4 illustrates a functional block diagram of an HMD 110 according to the first embodiment.

FIG. 5 illustrates a functional block diagram of the controller 210 according to the first embodiment.

FIG. 6 illustrates a functional block diagram of an image generating apparatus 310 according to the first embodiment.

FIG. 7 illustrates a view of an example of a virtual space displayed on a user device according to the first embodiment.

FIG. 8 illustrates a flow diagram describing a method for controlling a character according to the first embodiment.

FIG. 9 illustrates a flow diagram describing a method for controlling a character according to the first embodiment.

FIG. 10 illustrates a functional block diagram of an image generating apparatus 1010 according to a second embodiment.

FIG. 11 is a view showing an example of a virtual space displayed on a user device according to the second embodiment.

FIG. 12 is a view showing another example of a virtual space displayed on a user device according to the second embodiment.

FIG. 13 illustrates a flow diagram as an example of a process in which a character and an item interact in a virtual space in the second embodiment.

FIG. 14 illustrates a flow diagram as an example of a process in which a character and an item interact in a virtual space according to a third embodiment.

FIG. 15 illustrates an example of an item management table 1510 stored in an item data storage unit 1054 of an image generating apparatus 1010.

FIG. 16 illustrates a flow diagram as an example of a process in which a character and an item interact in a virtual space according to a fourth embodiment.

FIG. 17 illustrates an example of a user ranking management table 1610 stored in a user data storage unit 1055 of the image generating apparatus 1010.

FIG. 18 illustrates an example of a virtual space user interface for an actor user, according to a fifth embodiment.

### DETAILED DESCRIPTION OF THE EMBODIMENTS

### First Embodiment

A specific example of a program for controlling a head mounted display system according to an embodiment of the present invention will be described below with reference to the accompanying drawings. It should be noted that the present invention is not limited to these illustrative examples, but is defined by the scope of the claims, and it is intended to include all modifications within the meaning and scope equivalent to the claims. In the following description, the same reference numerals are given to the same elements in the description of the drawings, and redundant explanations are omitted.

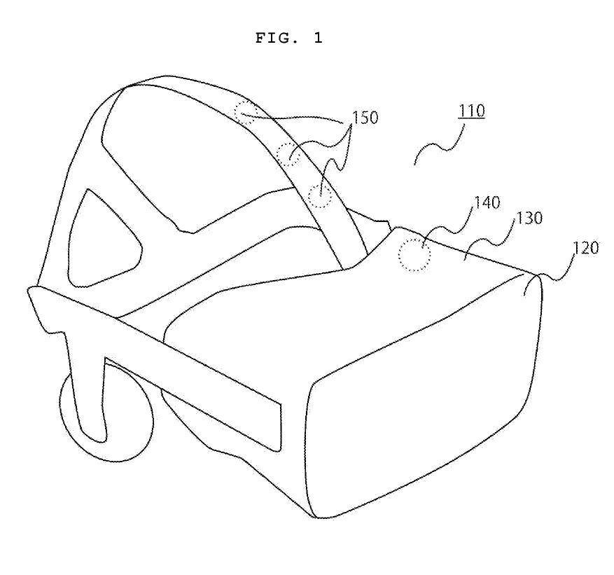

FIG. 1 illustrates a schematic view of an appearance of a head mounted display (hereinafter, HMD) 110 according to this embodiment. The HMD 110 is mounted to the head of a user and so as to have a display panel 120 arranged in front of the left and right eyes of the user. As a display panel, optical transmissive and non-transmissive displays are conceivable, but in this embodiment, a non-transmissive display panel capable of providing a more immersive feeling is exemplified. On the display panel 120, an image for the left eye and an image for the right eye are displayed, and by using the parallax of both eyes, an image having a three-dimensional effect can be provided to the user. If it is possible to display the image for the left eye and the image for the right eye, it is also possible to provide the left eye display and the right eye display individually, and it is also possible to provide an integrated display for the left eye and the right eye.

Further, a case unit 130 of the HMD 110 includes a sensor 140. Although not illustrated, the sensor may include any one of for example, a magnetic sensor, an acceleration sensor, a gyro sensor, or a combination thereof in order to detect a movement such as an orientation and inclination of the head of the user. The vertical direction of the head of the user is set as the Y axis. Among the axes orthogonal to the Y axis, an axis that corresponds to an axis connecting the center of the display panel 120 and the user in a front and rear direction of the user is defined as the Z axis. When the axis that corresponds to an axis that is perpendicular to the Y axis and the Z axis in a lateral direction of the user is defined as an X axis, the sensor 140 can detect the rotation angle about the X axis (known as a pitch angle), the rotation angle around the Y axis (knowns as a yaw angle), and the rotation angle around the Z axis (known as a roll angle).

Further, alternatively, in place of the sensor 140, the housing portion 130 of the HMD 110 may include a plurality of light sources 150 (for example, infrared light LEDs, visible light LEDs). A camera (for example, an infrared light camera, a visible light camera) installed outside the HMD 110 (for example, indoors) detects these light sources, and thereby it is possible to detect the position, orientation, inclination of the HMD 110 in a specific space. Or, for the same purpose, the HMD 110 may be provided with a camera for detecting the light source installed on the case unit 130 of the HMD 110.

Further, the case unit 130 of the HMD 110 may be provided with an eye tracking sensor. The eye tracking sensor is used to detect the gazing direction and fixation point of the left and right eyes of the user. Various methods are conceivable as the eye tracking sensor. For example, a method wherein the position of a reflected light on the cornea formed by irradiating weak infrared light on the left eye and the right eye is set as a reference point to detect a line-of-sight direction according to the position of the pupil with respect to the position of the reflected light, and a point of intersection of the line-of-sight direction of the left eye and the right eye is detected as a fixation point, and the like may be considered.

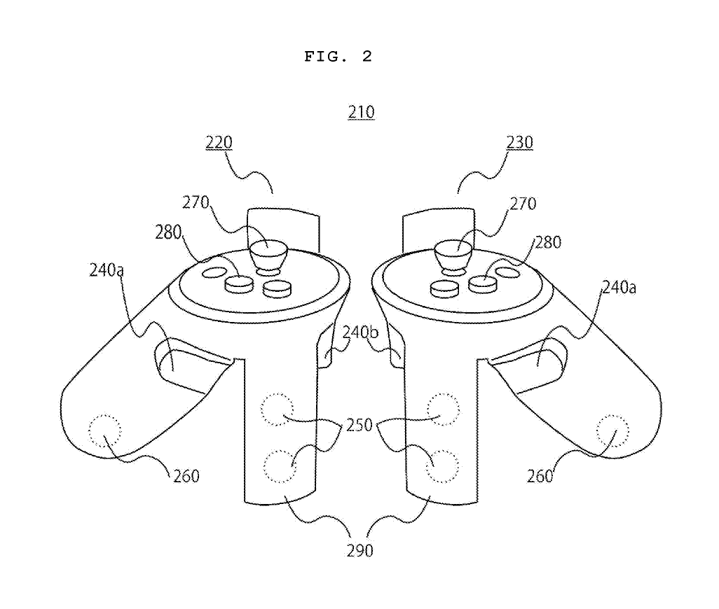

FIG. 2 illustrates a schematic diagram of an appearance of a controller 210 according to the present embodiment. The controller 210 can support the user to make predetermined inputs within virtual space. The controller 210 may be configured as a set of controllers for the left hand 220 and the right hand 230. The left-hand controller 220 and the right-hand controller 230 may each have a trigger button 240 for operation, an infrared LED 250, a sensor 260, a joystick 270, a menu button 280.

When grabbing a grip 235 of the controller 210, the operation trigger button 240 is arranged as a position 240a, 240b at a position assumed to perform an operation to pull the trigger with the middle finger and the index finger. A plurality of infrared LEDs 250 is provided on a frame 245 formed in a ring shape downward from both side surfaces of the controller 210, and the position of these infrared LEDs is detected by a camera (not shown) provided outside the controller, thereby it is possible to detect the position, orientation and inclination of the controller 210 in a specific space.

In addition, the controller 210 can incorporate the sensor 260 in order to detect the movement such as the orientation and inclination of the controller 210. As the sensor 260, although not shown, it is possible to include for example, any one of a magnetic sensor, an acceleration sensor, a gyro sensor, or a combination thereof. Further, on the upper surface of the controller 210, a joystick 270 and a menu button 280 may be provided. The joystick 270 can be moved in a direction of 360 degrees around a reference point. It is assumed that the joystick 270 is operated with the thumb when gripping the grip 235 of the controller 210. Similarly, the menu button 280 is assumed to be operated with the thumb. Furthermore, the controller 210 may also incorporate a vibrator (not shown) for providing vibration to the user's hand that operates the controller 210. In order to output information such as the contents input by the user via buttons and a joystick and the position, orientation, and inclination of the controller 210 via a sensor and the like, and to receive information from a host computer, the controller 210 is configured to have an Input-Output Unit (I/O unit) and a communication unit.

By the presence or absence of a user holding the controller 210 and operating the various buttons and joystick and by the information detected by the infrared LED or sensor, the system determines the movement or position of the user's hand, and the user's hand can be similarly displayed and operated in virtual space.

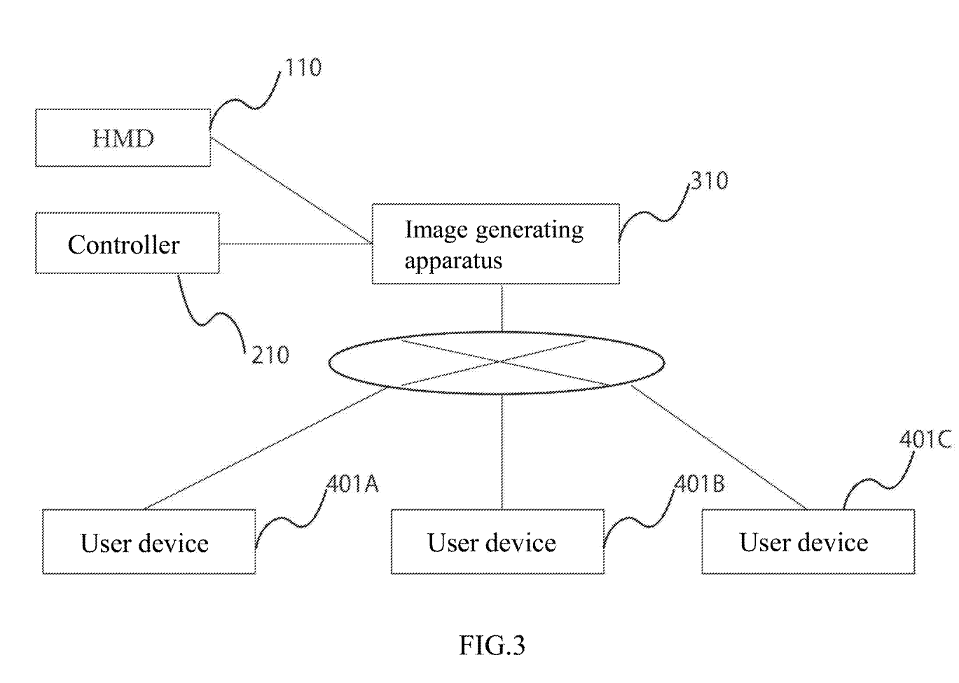

FIG. 3 illustrates a block diagram of the HMD system 300 according to the present embodiment. The HMD system 300 may be configured to have, for example, an HMD 110, a controller 210, and an image generating apparatus 310 functioning as a host computer. Further, an infrared camera (not shown) or the like for detecting the position, orientation, tilt, etc. of the HMD 110 and the controller 210 may be added. These devices can be connected to each other by wired or wireless means. For example, each device can be provided with a USB port and connected by a cable to establish communication, and it is also possible to establish communication by other wired or wireless means such as HDMI, wired LAN, infrared, Bluetooth (registered trademark) and WiFi (registered trademark). The image generating apparatus 310 may be any device having a calculation processing function such as a PC, a game machine, a mobile communication terminal, or the like. In addition, the image generating apparatus 310 may connect with a plurality of user devices such as user devices 401A, 401B 401C to transmit a generated image in a streaming or download form over a network such as the Internet. Each of the user devices 401A and the like may be provided with an Internet browser or an appropriate viewer so that the transmitted image can be played. Here, the image generating apparatus 310 can directly transmit images to a plurality of user devices or can transmit images via other contents servers.

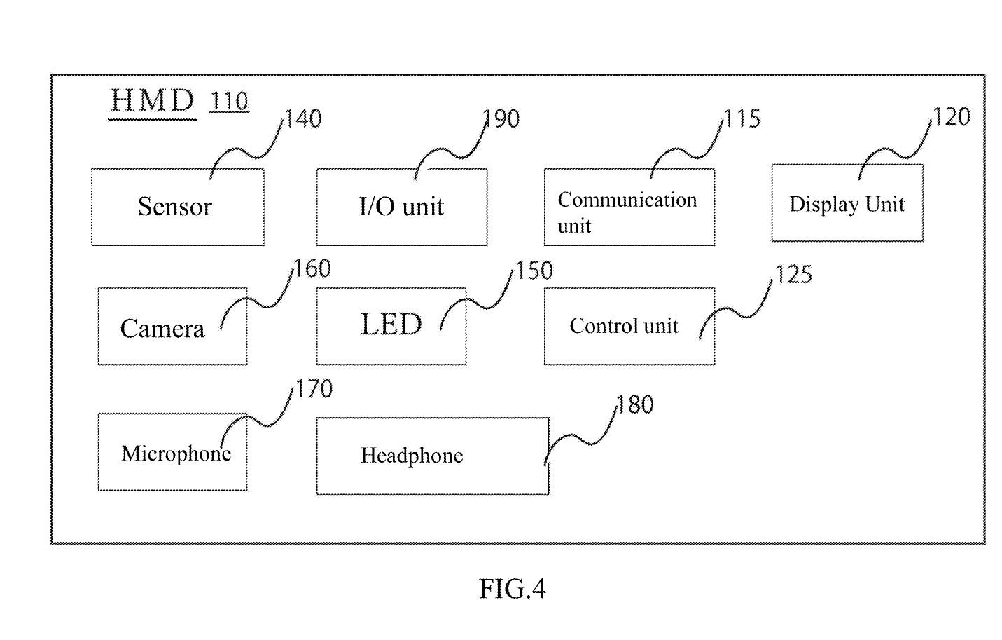

FIG. 4 illustrates a functional configuration diagram of the HMD 110 according to the present embodiment. As mentioned in FIG. 1, the HMD 110 may include a sensor 140. The sensor may include any one of for example, a magnetic sensor, an acceleration sensor, or a gyro sensor, or a combination thereof, although not shown, in order to detect a movement such as an orientation and inclination of the head of the user. Furthermore, an eye tracking sensor may be provided. The eye tracking sensor is used to detect the line-of-sight direction and fixation point of the left and right eyes of the user. LEDs 150 such as infrared light and ultraviolet light can be provided to detect movements such as the orientation and inclination of the head of the user more accurately or to detect the position of the head of the user more accurately. In addition, a camera 160 for photographing the outside of the HMD can be provided. Further, there may be provided a microphone 170 for collecting user's speech and a headphone 180 for outputting sound. It should be noted that the microphone and the headphone can be provided separately and independently from the HMD 110.

Further, the HMD 110 may, for example, include an I/O unit 190 for establishing a wired connection with peripheral devices, such as the controller 210 or the image generating apparatus 310. The HMD 110 may also include a communication unit 115 for establishing a connection using wireless means such as infrared ray, Bluetooth (registered trademark) or WiFi (registered trademark). Information relating to the movement such as the orientation and inclination of the head of the user acquired by the sensor 140 is transmitted to the image generating apparatus 310 via the I/O unit 190 and/or the communication unit 115 by the control unit 125. Although details will be described later, in the image generating apparatus 310, an image generated based on the movement of the head of the user is received via the I/O unit 190 and/or the communication unit 115 and is output on a display unit 120 due to the control unit 125.

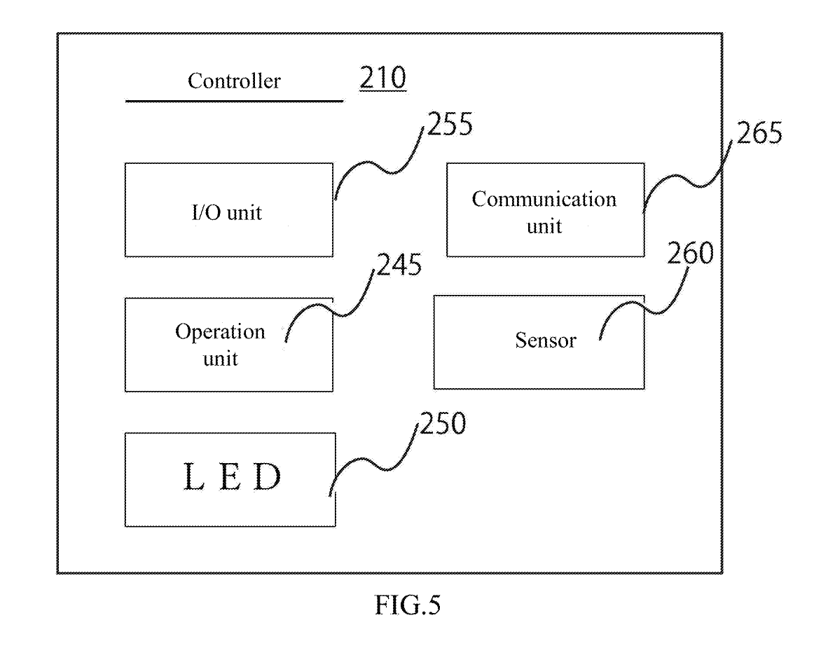

FIG. 5 illustrates a functional block diagram of the controller 210 according to the present embodiment. As mentioned in FIG. 2, the controller 210 can be configured as a set of controllers for the left hand 220 and the right hand 230, but for any controller, there may be provided an operation unit 245 such as, an operation trigger button 240, a joystick 270, and a menu button 280. In addition, the controller 210 can incorporate the sensor 260 in order to detect the movement such as the orientation and inclination of the controller 210. Although not shown, as the sensor 260, it is possible to include, for example, any one of a magnetic sensor, an acceleration sensor, and a gyro sensor, or a combination thereof. Further, a plurality of infrared LEDs 250 may be provided and by a camera (not shown) provided outside the controller, the positions of such infrared LEDs are detected, thereby enabling the detection of the position, orientation, and inclination of the controller 210 in a specific space. The controller 210, for example, may be provided with an I/O unit 255 for establishing a wired connection with peripheral devices such as the HMD 110 or the image generating apparatus 310. The controller 210 may include a communication unit 265 for establishing a connection using wireless means such as infrared ray, Bluetooth (registered trademark) or WiFi (registered trademark). Information input by the user via the operation unit 245 and information such as the orientation and inclination of the controller 210 acquired by the sensor 260 are transmitted to the image generating apparatus 310 via the I/O unit 255 and/or the communication unit 265.

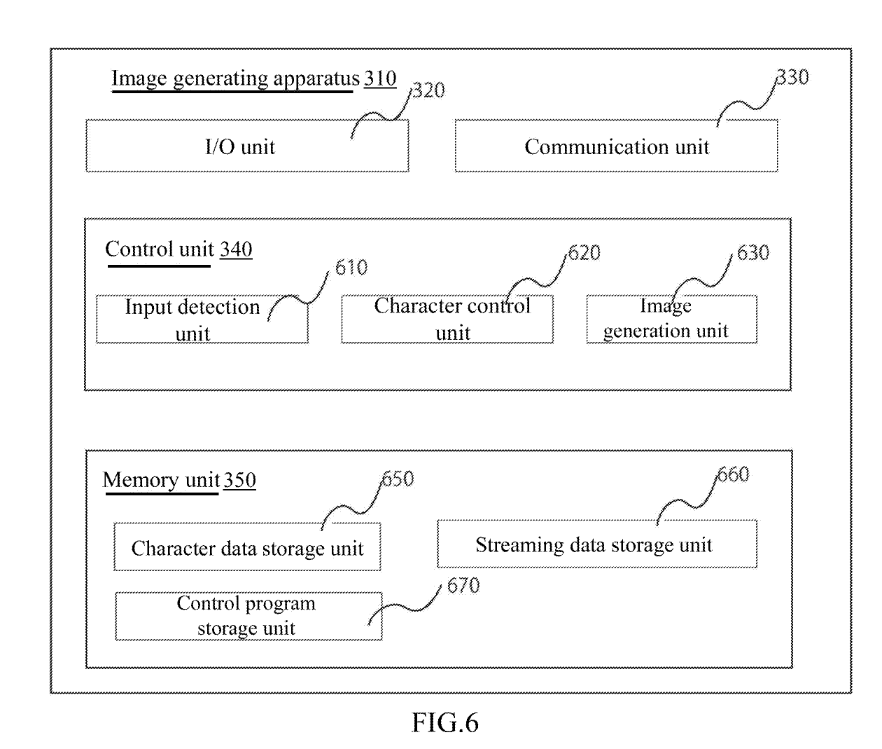

FIG. 6 illustrates a functional block diagram of the image generating apparatus 310 according to the present embodiment. As the image generating apparatus 310, a device capable of storing memory related to user input information transmitted from the HMD 110 or controller 210, or information related to the movement of the head of the user acquired by a sensor or the like or the movement or operation of the controller, which has functions for performing a predetermined calculation process for generating an image, such as a PC, a game machine, a mobile communication terminal or the like, may be used. The image generating apparatus 310 may include, for example, an I/O unit 320 for establishing a wired connection with peripheral devices, such as the HMD 110 or controller 210, and it may include a communication unit 330 for establishing wireless connection such as infrared ray, Bluetooth (registered trademark) or WiFi (registered trademark). Information relating to the movement of the head of the user received from the HMD 110 and/or controller 210 via the I/O unit 320 and/or communication unit 330 or the movement or operation of the controller is detected as input contents including the position, gaze, posture and the like, of the motion, speech and operation of the user in the control unit 340. By executing a control program stored in the memory unit 350 depending on the input contents of the user, a process such as controlling a character to generate an image is performed. The control unit 340 may be configured by a CPU, but by additionally installing a GPU specialized in image processing, it is possible to distribute information processing and image processing to improve the overall processing efficiency. Further, the image generating apparatus 310 can also communicate with other computing processing apparatuses and share information processing or image processing among the other computing processing apparatuses.

Further, the control unit 340 of the image generating apparatus 310 includes a user input detection unit 610 that detects information on the movement of the head of the user or the speech of the user received from the HMD 110 and/or controller 210, and information on the movement and operation of the controller, a character control unit 629 which executes a control program stored in a control program storage unit for a character stored in a character data storage unit 650 of the memory unit 350 in advance, and an image generation unit 630 that generates an image based on character control. Here, regarding the control of the movement of the character, information such as the orientation and inclination of the head of the user and movement of the hands detected via the HMD 110 or the controller 210, is converted to a movement of each portion of a bone structure created in accordance to the movement or restriction of joints of the human body, to associate the bone structure to the pre-stored character data. Thereby, the control of the movement of the character is realized by application of the movement of the bone structure.

The storage unit 350 stores information related to the character, such as character attributes in addition to the image data of the character, in the above-described character data storage unit 650. Further, the control program storage unit 670 stores a program for controlling the movement and facial expression of a character in the virtual space. A streaming data storage unit 660 stores the image generated by the image generation unit 630.

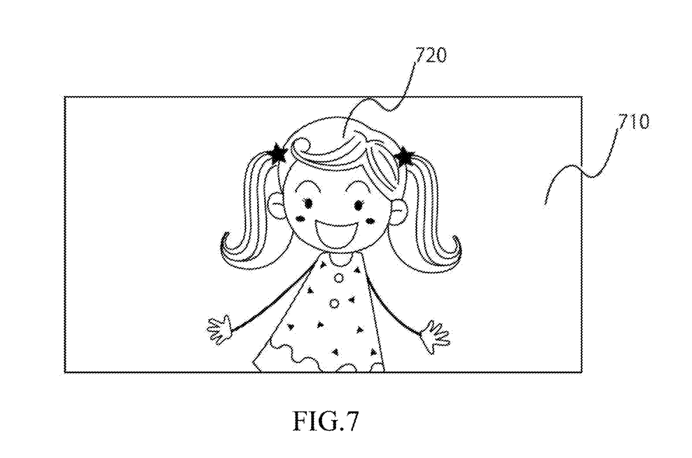

FIG. 7 is a diagram showing an example of a virtual space displayed on a user device according to the present embodiment. As shown in FIG. 7, a user device can display an image of a virtual space including a character 720, in an image display unit 710 such as a viewer for displaying an image embedded on an embedded web browser. The character 720 placed in the virtual space may move based on a movement such as the inclination and the orientation of the head of the user and speech contents of the user via the HMD 110 and/or the controller 210 mounted to the user as an actor, a movement such as the inclination and orientation of the controller 210, or user input such as the operation contents of the user via the controller 210.

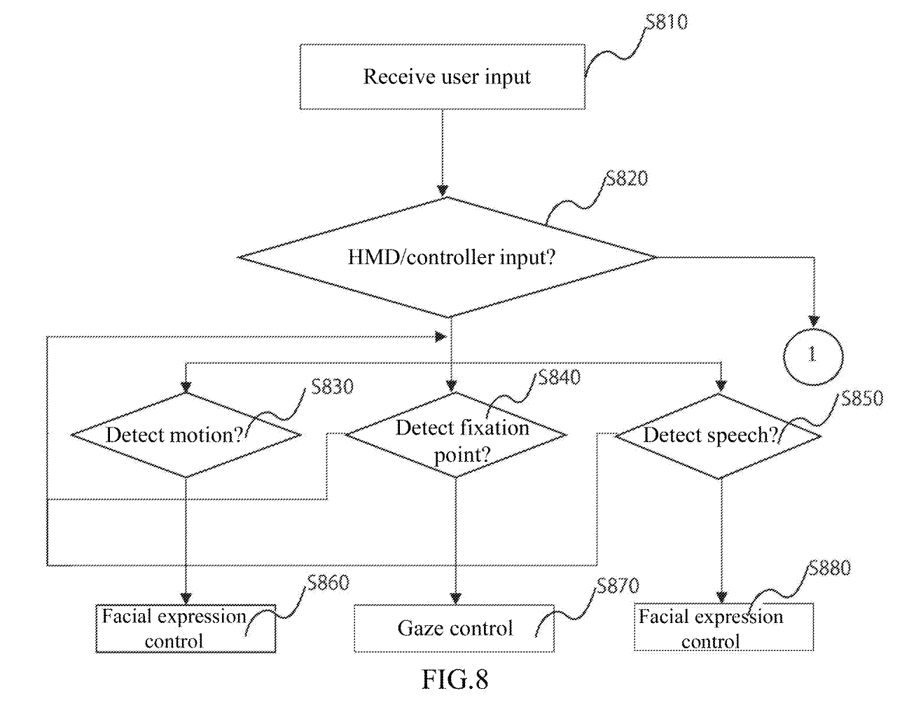

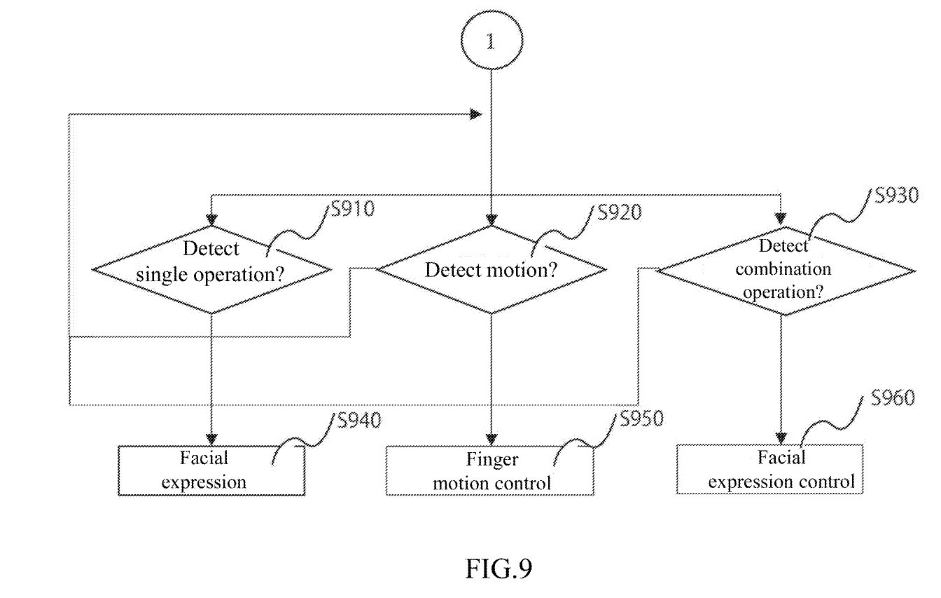

FIG. 8 and FIG. 9 illustrate a flow diagram for explaining the character control method according to the present embodiment. First, the user input detection unit 610 of the image generating apparatus 310 receives information related to the movement of the user's head or the utterance of the user via the I/O unit 320 and/or communication unit 330 from the HMD 110 and/or controller 210, or to the movement or operation of the controller (Step S810). Subsequently, the user input detection unit 610 confirms whether the input content of the user is input from the HMD 110 or input from the controller 210 (Step S820). If the process of step S820 was input from the HMD 110, the process proceeds to steps S830 to S850 for confirming the detailed input contents. If the process of step S820 was input from the controller 210, the process proceeds to the processing shown in FIG. 9.

If the process of S820 is input from the HMD 110, the user input detection unit 610 first confirms whether the content input from the HMD 110 is information related to the operation of the head of the user (S830). Specifically, when the information input from the sensor 140 of the HMD 110 relates to the orientation and inclination of the head of the user (e.g., rotation angle around the XYZ axes with reference to the head of the user), the character control unit 620 can change the movement of the head of the character (S860). Here, for example, information on the movement of the head of the user such as orientation and inclination detected by a gyro sensor of the HMD 110 is converted into a movement of the head of a bone structure defining the movement and restriction of the human joint, and by applying the movement of the head of the bone structure to the movement of the head of character data stored in the character data storage unit 650, it is possible to control the movement of the character. For example, when an information of “roll angle: − (minus) 30 degrees” around the Y axis is received from a gyro sensor on a microphone, the character control unit 620 performs a process with the information to change to character to shake its neck 30 degrees to the left direction of the head of the character. Further, it is also possible to change the facial expression of the character. As elements constituting the expression of the character expression character data, parts constituting the face of the character, for example, may be divided into eyebrows, eyes, nose, mouth or the like, and each of the parts may have a movement pattern and a degree of movement (magnitude, speed of movement) as parameters. By combining the parameters of these parts, the character can have various expressions such as happiness, anger, sadness and pleasure. In addition, by detecting the movement of the head of the user, its parameter can be controlled to be randomly changed in accordance with the movement. Thus, it is possible to reenact a natural facial expression of the character. Alternatively, the user input detection unit 610 confirms whether the input content is information related to the fixation point of the user in step S840. The fixation point is obtained by calculating the line-of-sight direction based on the information related to the orientation and inclination of the head of the user obtained through various sensors or obtained directly via an eye tracking sensor. The character control unit 620 can change the gaze of the character according to the line-of-sight direction or the position indicated by the fixation point in step S870. Alternatively, the user input detection unit 610 confirms whether the user input content is information related to the speech of the user in step S850. More specifically, when the user input content is a voice input from a microphone 170 of the HMD 110, the character control unit 620 controls the size of the mouth of the character according to the size of the voice and can control the character facial expression parameter to be randomly changed in step S880. Here, instead of mounting the HMD 110 on the head, for example, the user places the HMD 110 on the head and changes the movement of the HMD 110 while watching the image of the character displayed on an external monitor, thereby enabling realization of the character's movement in accordance to the movement of the HMD 110.

When the process of step S820 is input from the controller 210, the process proceeds to steps S910 to S930 of confirming detailed input contents in FIG. 9. First, the user input detection unit 610 confirms whether the input content from the controller 210 is information related to the operation of the operation button of the controller 210 in step S910. For example, when the input content relates to the depression of the operation trigger button 240a of the left-hand controller, the character control unit 620 can control the facial expression parameters so that the character takes an action that corresponds to the operation of the button (for example, smiling).

Alternatively, the user input detection unit 610 confirms whether the input content from the controller 210 relates to the operation, such as the position, orientation, inclination, or the like of the controller 210 detected via the sensor 260 provided in the controller 210 in step S920. In the case where the input content relates to operations such as the position, direction, inclination, etc. of the controller 210, the character control unit 620 can control the movement of the body of the character in step S950. For example, if the input content is related to change in position (movement of raising and lowering the controller) detected by an acceleration sensor of the controller 210, the character control unit 620 can be controlled so that an arm of a character moves up and down. Further, if the input content is related to rotation detected by a gyro sensor of the controller 210, the character control unit 620 can control the fingers of the character to open and close. Here, when the movements of the HMD 110 and controller 210 are combined, the character reenacts the corresponding movements of the head and hands. However, the movement of parts connecting the head and hands such as the neck and shoulders can be reinforced by using a technique called inverse kinematics (IK) of computer graphics to inversely calculate the movement of the neck and shoulders based on the movement of the head and hands which cannot be obtained via sensors. Alternatively, the user input detection unit 610 confirms whether the input content from the controller 210 is information related to a combination of operations of the operation buttons of the controller 210 in step S930. For example, if the input content is pressing an operation trigger button 240a of a left-hand controller and an operation trigger button 240a of a right-hand controller at the same time, the facial expression parameter or operation parameter can be controlled so that the character takes an action that corresponds to such a combination (for example, the character holding onto its stomach and laughing) in step S960. Here, like the facial expression parameter, parts constituting the whole body of the character for action of the body, for example, may be divided into the head, both hands, both legs and the like, and each of the parts may have a movement pattern and a degree of movement (magnitude, speed of movement) as parameters. In order to express the natural movement of the character, it is possible to randomly control the facial expression parameters and the operation parameters of the character in response to some input to the user via the HMD 110 or the controller 210.

According to the present embodiment, by detecting the movement and the operation content of each part of the user via the HMD 110 and the controller 210 instead of a marker or a sensor directly attached to the user's body, it is possible to facilitate reenactment of a character's movement which corresponds to a user's movement while realizing expressions rich in variations in accordance to the operation contents.

### Second Embodiment

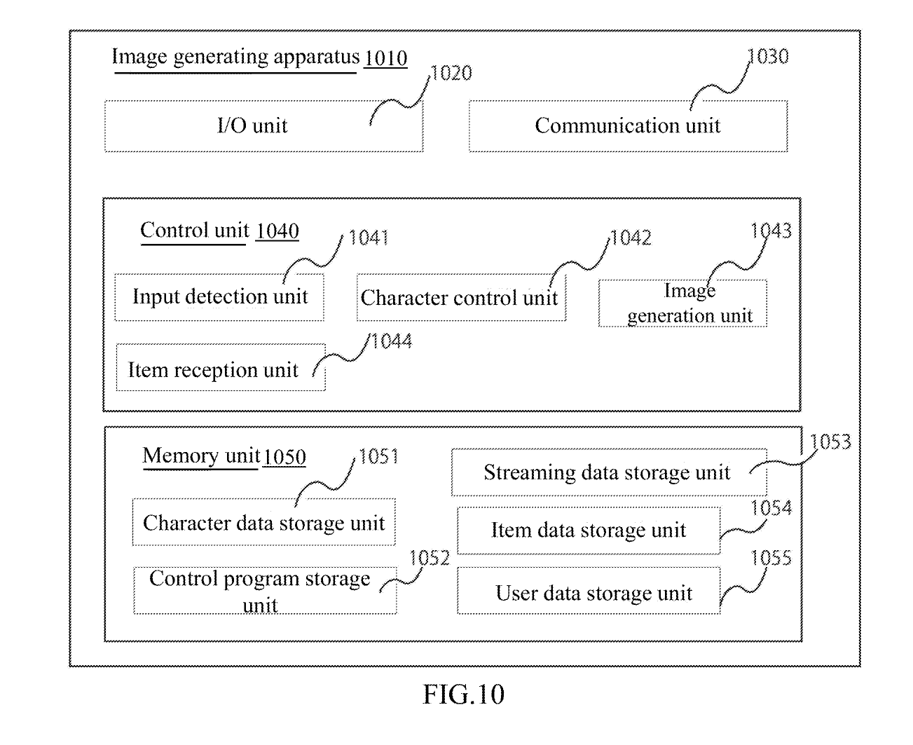

FIG. 10 illustrates a functional block diagram of the image generating apparatus 1010 according to a second embodiment. The HMD system according to the present embodiment is identical to the system configuration in the first embodiment shown in FIG. 3, and the functional configuration of the image generating apparatus 1010 is basically the same as the configuration shown in FIG. 6. In the present embodiment, in the image generating apparatus 1010, a control unit 1040 is configured to have an item reception unit 1044 for receiving a selection of items to be placed in a virtual space from other user devices. A memory unit is configured to have an item data storage unit 1054 for storing data related to items. Further, the memory unit 1050 is configured to have a user data storage unit 1055 for storing information related to users. As a feature of the image generating apparatus according to the present embodiment, it is possible not only to transmit a video to be a virtual space to a plurality of user devices but also to receive items and comments from the user devices. Further, as in the first embodiment, the function of the image generating apparatus 1010 is dedicated solely to generating images, and a separate contents service server is provided. This contents service server transmits an image to a user device and may also have a function of receiving items or comments from a user device.

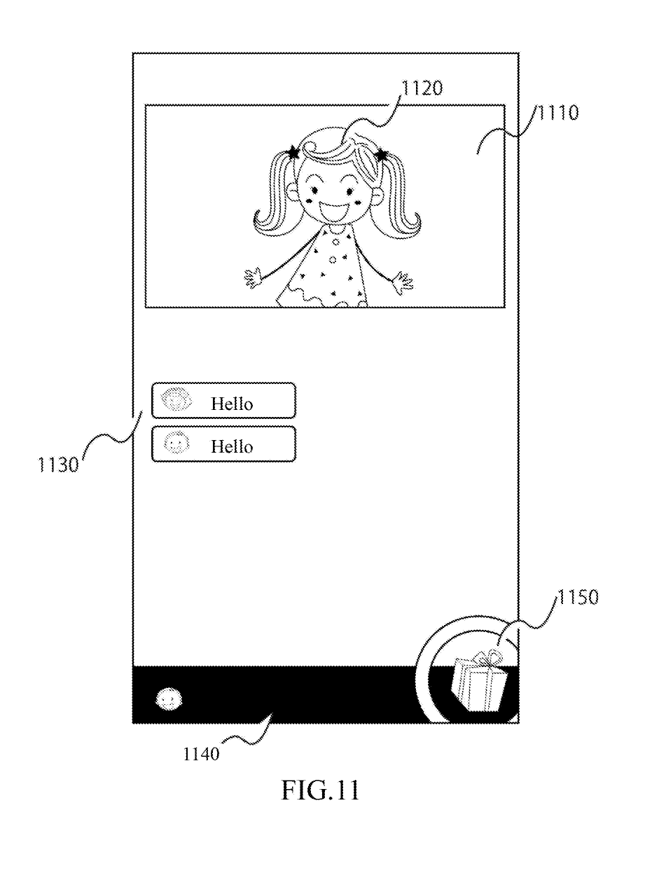

FIG. 11 is a view showing an example of a virtual space displayed on a user device according to the second embodiment. As in the first embodiment, a user device can display an image of a virtual space including a character 1120, in an image display unit 1110 such as a viewer for displaying an image embedded on an embedded web browser. The character 720 placed in the virtual space may be operated based on user input such as movement such as the inclination and orientation of the head of the user via the HMD 110 and/or controller 210 mounted on the user as an actor, the speech of the user, or movement such as the inclination and orientation of the controller 210, or the operation content of the user via the controller 210. In the present embodiment, in addition to the image display unit 1110, a comment display unit 1130 for displaying comments received from each user device connected to the image generating apparatus 310, a comment input unit 1140 for receiving comments input from a user, and an item display unit 1150 for selecting and displaying items for gifting a character, may be provided. In the present embodiment, a service including what is known as gifting is assumed, wherein for the characters displayed in a virtual space displayed on the image display unit 1110, each user support comment is received, and each user purchases desired items among the plurality of items of corresponding points, and by executing an input for making a transmission request, the purchased items are displayed in the virtual space. In such a service, it is conceivable that the character performs a predetermined action according to the cumulative number of points of the gifted items.

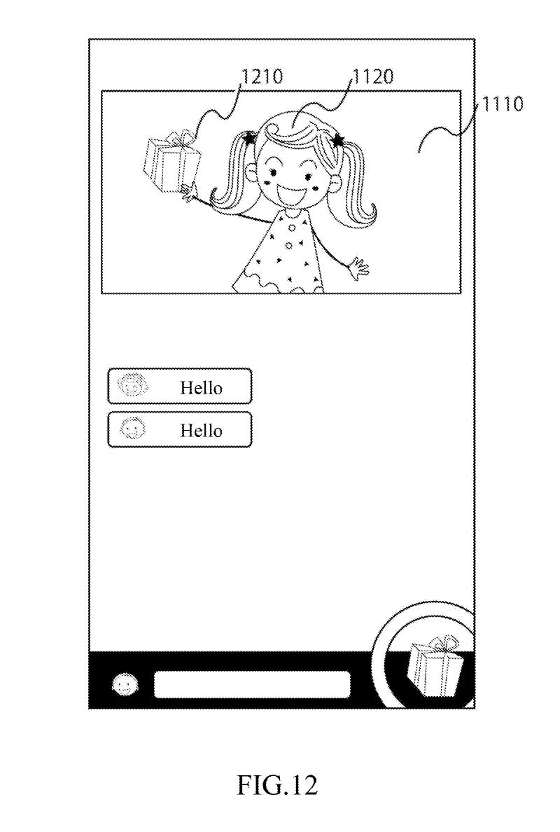

FIG. 12 is a view showing another example of a virtual space displayed on the user device according to the present embodiment. In this example, through gifting from one user device, a character 1120 is presented to seem happy while lifting the item 1210 placed in the image display unit 1110. As a result, the user and the character can share a greater sense of unity in the service.

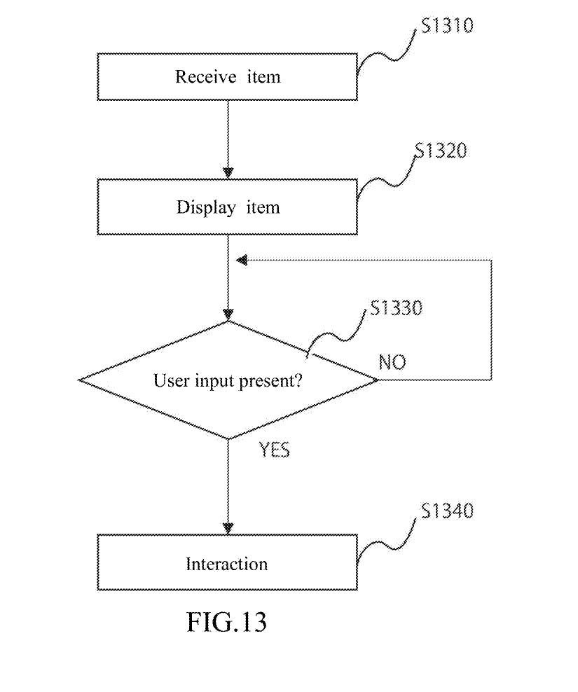

FIG. 13 illustrates a flow diagram as an example of a process in which a character and an item interact in a virtual space in the present embodiment. First, the item reception unit 1044 of the image generating apparatus 1010 receives an item from any one of a plurality of user devices connected to the service in step S1310. The image generation unit 1043 of the image generating apparatus 1010 generates an image on the image display unit 1110 of the user device to display an item 1210 together with a character 1120 in step S1320. Thereafter, the user input detection unit 1141 of the image generating apparatus 1010 confirms whether a user input was detected from the HMD 110 or controller 210 or the like of the user who is an actor in step S1330. For example, a user who is an actor may perform the operation of adjusting the position of the controller 210 with respect to the item 1210 while watching the virtual space displayed on the display of the HMD 110 and pulling the trigger of the left-hand or right-hand operation trigger button 240a. The user input detection unit 1141 can detect the operation by receiving the operation via the I/O unit 1020 and/or communication unit 1030 of the image generating apparatus 1010. If the user input detection unit 1041 does not detect user input, the process returns to the original process. If the user input detection unit 1041 detects a user input, the character control unit 1042 performs a process of moving the position of the hand of the character in accordance with the position of the controller 210 and converts the position of the controller to a coordinate in the virtual space. If this coordinate overlaps with the coordinate at which the item in the virtual space is placed, the process of grabbing the item is performed according to the operation via the controller 210 in the next step. As a result, the image generation unit 1043 generates an image wherein the character 1120 is lifting the item 1210, that is, an image of the character and item interacting in step S1340.

### Third Embodiment

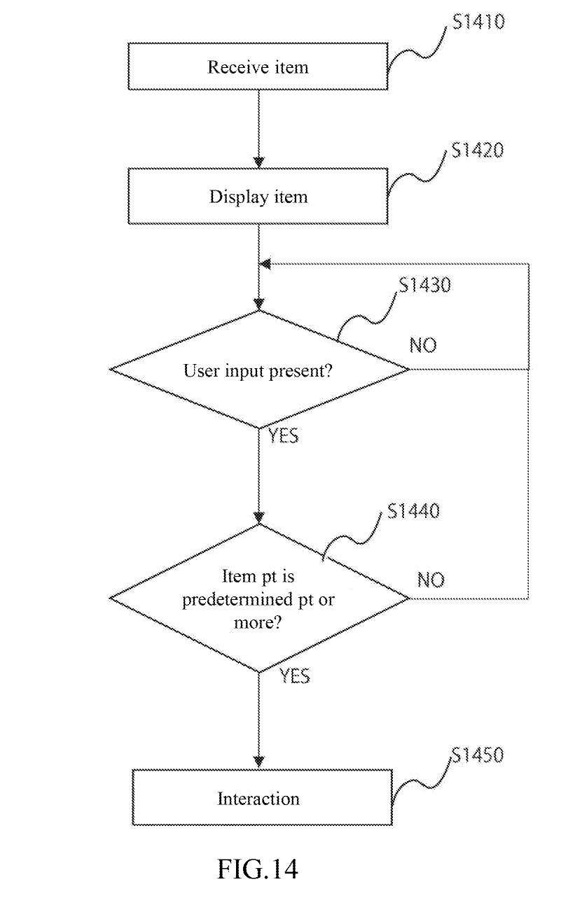

FIG. 14 illustrates a flow diagram as an example of a process in which a character and an item interact in a virtual space according to a third embodiment. In the present embodiment, in addition to an aspect of image processing, as a service, a method to further enhance the sociality of a character and user is provided. The configuration of the system and the image generating apparatus of the present embodiment is basically the same as that of the second embodiment.

Referring to FIG. 14, first, the item reception unit 1044 of the image generating apparatus 1010 receives an item from any one of a plurality of user devices connected to the service in step S1410. The image generation unit 1043 of the image generating apparatus 1010 generates an image on the image display unit 1110 of the user device to display the item 1210 together with a character 1120 in step S1420. Thereafter, the user input detection unit 1141 of the image generating apparatus 1010 confirms whether user input has been detected by the HMD 110 or controller 210 or the like of a user who is an actor in step S1430. For example, a user who is an actor may perform the operation of adjusting the position of the controller 210 with respect to the item 1210 while watching a virtual space displayed on the display of the HMD 110 and pulling the trigger of the left-hand or right-hand operation trigger button 240a. The user input detection unit 1141 can receive and detect the operation via an I/O unit 1020 and/or a communication unit 1030 of the image generating apparatus 1010. If the user input detection unit 1041 does not detect a user input, the process returns to the original process. If the user input detection unit 1041 detects a user input, the character control unit 1042 confirms the number of points of the item 1210 placed in virtual space and continues to confirm whether the number of points is greater than or equal to a predetermined point in step S1440.

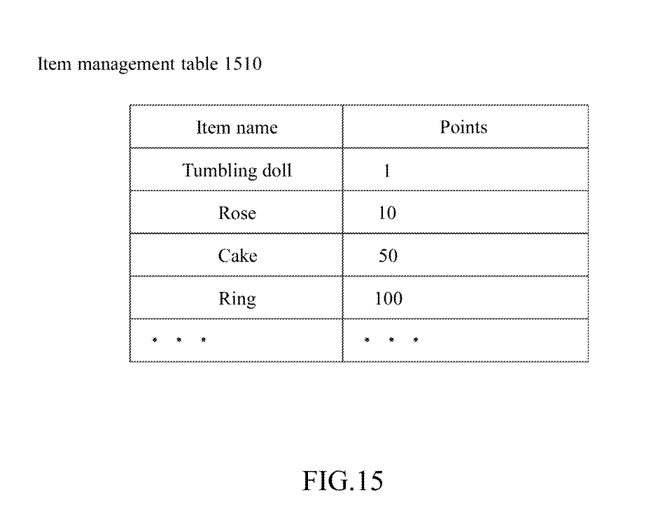

FIG. 15 illustrates an example of an item management table 1510 stored in an item data storage unit 1054 of an image generating apparatus 1010. The item management table 1510 manages items that the user can gift and the number of corresponding points. Here, the number of points refers to the number necessary for purchasing items one by one when the virtual currency that is valid within the service is provided in units of points. For example, while the number of points is “1” for the item “Tumbling doll”, the number of points is assigned as “10” for the item “Rose”. The user purchases the item with points to support the character (or the actor) and requests to display the purchased item in the virtual space. In the example listed in the item management table 1510, “Ring” is the most expensive item.

Returning to step S1440 of FIG. 14, if the predetermined number of points is set to “10 pt”, for example, and if the placed item is a “Tumbling doll”, the character control unit 1042 does not execute the character control and the process returns to the original process. On the other hand, if the placed item is “Rose”, the number of points of the rose is “10 pt”, so the condition is satisfied. Upon confirming that the condition is satisfied, the character control unit 1042 performs a process of moving the position of the hand of the character in accordance with the position of the controller 210 and converts the position of the controller to a coordinate in virtual space. If this coordinate overlaps with the coordinate at which the item in the virtual space is placed, the process of grabbing the item is performed according to the operation via the controller 210 in the next step. As a result, the image generation unit 1043 generates an image wherein the character 1120 is lifting the item 1210, that is, an image of the character and item interacting in step S1450.

### Fourth Embodiment

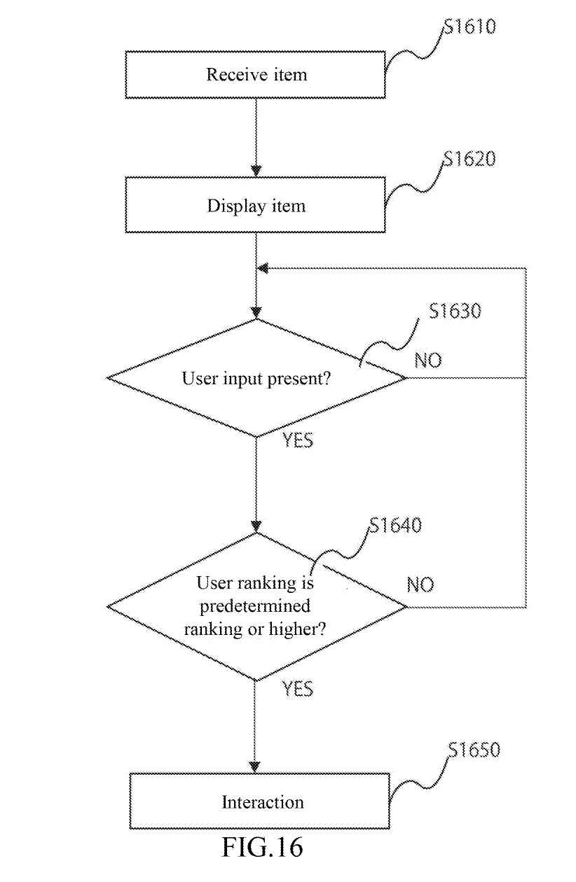

FIG. 16 illustrates a flow diagram as an example of a process in which a character and an item interact in a virtual space according to a fourth embodiment. In the present embodiment, in addition to an aspect of image processing, as a service, another method to further enhance the sociality of a character and user is provided. The configuration of the system and the image generating apparatus of the present embodiment is basically the same as that of the second and third embodiments.

Referring to FIG. 16, first, the item reception unit 1044 of the image generating apparatus 1010 receives an item from any one of a plurality of user devices connected to the service in step S1610. The image generation unit 1043 of the image generating apparatus 1010 generates an image on the image display unit 1110 of the user device to display an item 1210 together with a character 1120 in step S1620.

Thereafter, the user input detection unit 1141 of the image generating apparatus 1010 confirms whether a user input was detected from the HMD 110 or controller 210 or the like of the user who is an actor in step S1630. For example, a user who is an actor may perform the operation of adjusting the position of the controller 210 with respect to the item 1210 while watching the virtual space displayed on the display of the HMD 110 and pulling the trigger of the left-hand or right-hand operation trigger button 240a. The user input detection unit 1141 can detect the operation by receiving the operation via the I/O unit 1020 and/or communication unit 1030 of the image generating apparatus 1010. If the user input detection unit 1041 does not detect user input, the process returns to the original process. If the user input detection unit 1041 detects a user input, the character control unit 1042 performs a process of confirming the ranking of the user who has gifted the item 1210 placed in the virtual space and continues to confirm if the number of points is greater than or equal to a predetermined ranking in step S1640.

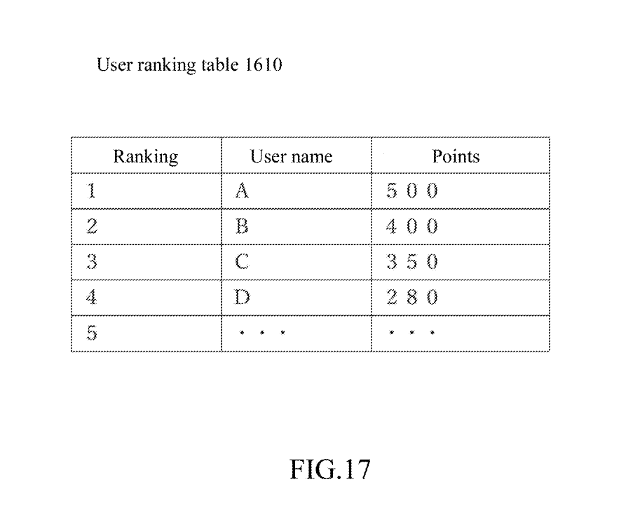

FIG. 17, illustrates an example of a user ranking management table 1610 stored in a user data storage unit 1055 of the image generating apparatus 1010. The user ranking management table 1610 manages the total number of points corresponding to the items that a user gifted, and manages the ranking based on the total number of points. For example, if user A purchases and gifts five items of “Ring”, the total number of points become “500 pt”, and with the comparison between other users, ranks first place in the total number of points.

Returning to step S1640 in FIG. 16, for example, when the predetermined ranking is “third place or more” and if the user who gifted the placed item was “User D”, the character control unit 1042 does not execute character control because user D ranks fourth place, and the process returns to the original process. On the other hand, if the user who gifted the placed item was “User C”, because user C ranks third place, the condition is satisfied. Upon confirming that the condition is satisfied, the character control unit 1042 performs a process of moving the position of the hand of the character in accordance with the position of the controller 210 and converts the position of the controller to a coordinate in virtual space. If this coordinate overlaps with the coordinate at which the item in the virtual space is placed, the process of grabbing the item is performed according to the operation via the controller 210 in the next step. As a result, the image generation unit 1043 generates an image wherein the character 1120 is lifting the item 1210, that is, an image of the character and item interacting in step S1650.

### Fifth Embodiment

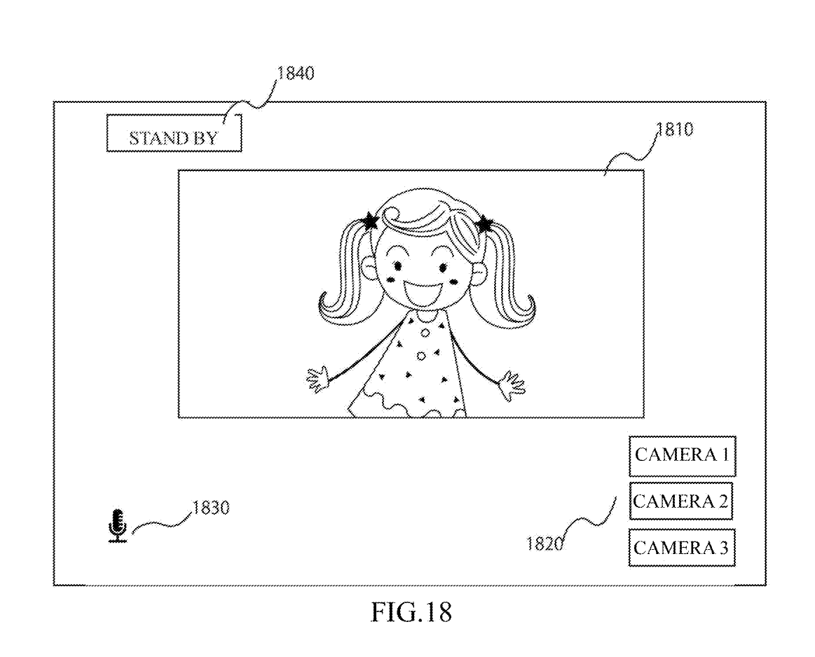

FIG. 18 illustrates an example of a virtual space user interface for an actor user, according to a fifth embodiment. In the present embodiment, by mounting the HMD 110 on the head, an actor user can confirm the character that operates based on the action that he/she is performing in the virtual space 1810 displayed on the display unit 120. Some panels exist in this virtual space 1810, and the actor user can act while changing the position of virtual cameras or performing other operations.

In FIG. 18, a virtual camera selection unit 1820 for manipulating the position of a virtual camera is provided. For example, the actor user can select a desired virtual camera by moving the position of the controller 210 to a position where a button of a specific camera is displayed and pressing an operation button of the controller 210. For example, the virtual camera can be placed in a position facing front, diagonally 45 degrees to the left, 45 degrees to the right, or the like towards where a character is placed. In addition, an icon 1830 indicating that the voice of the actor user is being recorded can be placed. For example, the actor user can execute a recording operation by pressing a specific operation button of the controller 210. Further, the actor user can check the recording status through the mode of the icon 1730. In addition, a “STAND BY” icon 1840 can be placed in the virtual space, and the actor user can check the status whether the distribution is being prepared or on air through the icon 1840. Although not shown, it is also possible to perform a process of displaying particles from the mouth of the character corresponding to the voice and the volume emitted by the actor user, and it is possible to check the status intuitively by increasing the size of the particle in accordance to the magnitude of the volume.

### REFERENCE NUMERALS

110 Head Mounted Display
115 Communication unit
120 Display panel
125 Control unit
140 Sensor
150 Light source
160 Camera
170 Microphone
180 Headphone
190 I/O unit
210 Controller
220 Left-hand controller
230 Right-hand controller
240a, 240b Trigger button
245 Operation unit
250 Infrared LED
255 I/O unit
260 Sensor
270 Joystick
280 Menu button
290 Frame
310 Image generating apparatus
320 I/O unit
330 Communication unit
340 Control unit
350 Memory unit
401A, 401B, 401C User device
610 User input detection unit
620 Character control unit
630 Image generation unit
650 Character data storage unit
660 Streaming data storage unit
670 Control program storage unit
710 Image display unit
720 Character
1110 Image display unit
1120 Character
1130 Comment display unit
1140 Comment input unit
1150 Item display
1210 Items
1810 Virtual space
1820 Virtual camera selection unit
1830 Icon
1840 Icon

1. A method for controlling a character in a virtual space provided to a plurality of user devices, comprising,
placing a character played by a first user in a virtual space displayed on respective user devices of the plurality of user devices;
detecting an input of the first user through any one of a head mounted display or a controller attached to the first user;
controlling motion of the character based on the input of the first user;
displaying a plurality of selectable objects in an area different from the virtual space in the respective user devices;
receiving a selection of an object of any one of the plurality of objects from a user device associated with a second user of any one of the plurality of user devices;
placing the one object in the virtual space; and
when an input of the first user for the one object is detected, controlling the character so as to grab the object.

2. The control method of claim 1, wherein, when the placed object is more than or equal to a predetermined point, the character is controlled to grab the object.

3. The control method of claim 2, wherein, a plurality of objects is associated with respective points, and based on a total number of points of an object placed in the virtual space comprising one object placed in the virtual space, a ranking of the second user among the plurality of users is generated, and when the corresponding ranking is greater than or equal to a predetermined ranking, the character is controlled to grab the object.
